(19) United States
(12) Patent Application Publication
(10) Pub. No.: US 2013/0060505 A1
(43) Pub. Date: Mar. 7, 2013

(54) TECHNIQUE FOR WAFER TESTING WITH MULTIDIMENSIONAL TRANSFORM

(71) Applicant: Michael J. Brennan, Stouffville (CA)

(72) Inventor: Michael J. Brennan, Stouffville (CA)

(73) Assignee: ATI Technologies ULC., Markham (CA)

(21) Appl. No.: 13/227,070

(22) Filed: Sep. 7, 2011

(51) Int. Cl. G06F 19/00

(52) U.S. Cl. 702/117

(57) ABSTRACT

Wafer sort data can be converted to binary data, whereby each integrated circuit of the wafer is assigned a value of one or zero, depending on whether test data indicates the integrated circuit complies with a specification. In addition, each integrated circuit is assigned position data to indicate its position on the wafer. A frequency transform, such as a multidimensional discrete Fourier transform (DFT), is applied to the binary wafer sort data and position data to determine a spatial frequency spectrum that indicates error patterns for the wafer. The spatial frequency spectrum can be analyzed to determine the characteristics of the wafer formation process that resulted in the errors, and the wafer formation process can be modified to reduce or eliminate the errors.

### BACKGROUND

1. Field of the Disclosure

The present disclosure generally relates to integrated circuit devices and more particularly testing integrated circuit device wafers.

2. Description of the Related Art

Integrated circuit devices are typically produced by forming the devices on sets of integrated circuit wafers, whereby each wafer includes multiple integrated circuit devices. The behavior of each integrated circuit device depends on a number of variable factors, including the device formation process, equipment variations, environmental variations, and the like. Further, these factors can also cause variation in the behavior of different integrated circuit devices formed on the same wafer. In some cases, the variation in behavior can result in one or more integrated circuit devices of a wafer to fail relative to a device specification. Such integrated circuit devices are referred to as failed devices and, because of the expense in producing each wafer, it is desirable to minimize the number of failed devices.

### BRIEF DESCRIPTION OF THE DRAWINGS

The present disclosure may be better understood, and its numerous features and advantages made apparent to those skilled in the art by referencing the accompanying drawings.

FIG. 1 is a diagram illustrating an integrated circuit wafer in accordance with one embodiment of the present disclosure.

FIG. 2 is a graphical diagram illustrating test results for the integrated circuit wafer of FIG. 1 in accordance with one embodiment of the present disclosure.

FIG. 3 is a graphical diagram illustrating a frequency spectrum of the test results of FIG. 2 in accordance with one embodiment of the present disclosure.

FIG. 4 is a block diagram of a wafer testing system in accordance with one embodiment of the present disclosure.

FIG. 5 is a flow diagram illustrating a method of determining error patterns at a set of integrated circuit wafers in accordance with one embodiment of the present disclosure.

The use of the same reference symbols in different drawings indicates similar or identical items.

### DETAILED DESCRIPTION

FIGS. 1-5 illustrate techniques for employing a frequency transform to determine error patterns in an integrated circuit wafer. In particular, wafer sort data can be converted to binary data, whereby each integrated circuit of the wafer is assigned a value of one or zero, depending on whether test data indicates the integrated circuit complies with a specification. In addition, each integrated circuit is assigned position data to indicate its position on the wafer. A frequency transform, such as a multidimensional discrete Fourier transform (DFT), is applied to the binary wafer sort data and position data to determine a spatial frequency spectrum that indicates error patterns for the wafer. The spatial frequency spectrum can be analyzed to determine the characteristics of the wafer formation process that resulted in the errors, and the wafer formation process can be modified to reduce or eliminate the errors.

FIG. 1 illustrates a block diagram 100 of an integrated circuit wafer 102 (referred to as wafer 102) in accordance with embodiment of the present disclosure. Block diagram 100 further illustrates an x-axis 110, indicating x-coordinate values, and a y-axis 115, indicating y-coordinate values. The wafer 102 is formed according to an integrated circuit formation procedure, and includes a set of integrated circuits, such as integrated circuits 105 and 106. Each of the integrated circuits will exhibit specific behavior in response to designated stimuli. In the illustrated embodiment, each box represents an integrated circuit, and the shading of the box indicates a particular response to stimuli. Thus, for example, the shading of the box can indicate an amount of leakage current exhibited by the corresponding integrated circuit in response to a designated power level being applied to one or more pins of the integrated circuit.

In an embodiment, the wafer 102 is tested by wafer test equipment that applies stimuli to each integrated circuit of the wafer 102 and measures the responsive behavior. Further, the test equipment can assign each integrated circuit to one of a set of categories, referred to as bins, according to its measured behavior. The resulting set of data for the wafer 102 is referred to as wafer sort data. Thus, for example, each integrated circuit of the wafer 102 measured to have a leakage current in one range of values is assigned to one bin, each integrated circuit measured to have a leakage current in another range of values is assigned to another bin, and each integrated circuit measured to have a leakage current in yet another range of values is assigned to still another bin. In the illustrated example of FIG. 1, the particular bin to which an integrated circuit has been assigned is indicated by the shading of the box for that integrated circuit. Thus, integrated circuit 105 is assigned to one bin together with other integrated circuits having a light-gray shading, integrated circuit 106 is assigned to another bin together with other integrated circuits indicated by the cross-hatch shading, integrated circuit 107 is assigned to yet another bin together with other integrated circuits indicated by a medium-gray shading, and integrated circuit 108 is assigned to yet another bin.

During the wafer testing process, the behavior of each integrated circuit of the wafer 102 can be compared to a specification to determine whether each integrated circuit is predicted to operate within specified parameters. In an embodiment, the specification indicates a parameter range for a behavior, and the bin assigned to the integrated circuit indicates whether the behavior of the integrated circuit is predicted to fall within or outside the parameter range. Thus, for example, the specification can indicate a range or threshold amount for the acceptable amount of leakage current, and the bin assigned to an integrated circuit can be indicative of whether the integrated circuit is predicted to exceed the range or threshold amount. An integrated circuit whose predicted behavior is outside the range indicated by the specification is referred to as a failed integrated circuit.

Failed integrated circuits can result from errors in the wafer formation process, such as equipment failures, equipment that has been improperly configured, unsuitable environmental conditions, and the like. Further, such errors can cause a spatial periodicity in the failure of integrated circuits of a wafer or set of wafers. That is, errors in the wafer formation process can cause the wafer to be formed to have number of failed integrated circuits, whereby the failed integrated circuits are arranged according to a spatial pattern. The pattern can be a periodic pattern, a quasi-periodic pattern, or other pattern. However, such patterns can be difficult to identify through simple examination of wafer sort or other test data. Accordingly, in an embodiment a frequency transform can be applied to the test data to convert the data into the frequency domain. As used herein, a frequency transform is any mathematical operation or procedure that decomposes a signal into its constituent frequencies. The signal can be defined by the test data that is being transformed.

An example of a frequency transform is the discrete Fourier transform (DFT). The 1-dimensional The 1-dimensional Fourier transform of a discrete function is as follows:

$$F ( μ ) = \frac{1}{M} {\sum }_{x = 0}^{M - 1} f ( x ) exp [ - 2 j π ( \frac{μ x}{M} ) ]$$

where f(x) is a discrete function, M is the total number of samples and μ is the frequency defined as μ/M cycles per sample. In addition, the frequency transform can be multidimensional. Given a 2-dimensional dataset consisting of M data points for x and N data points for y, the 2 dimensional DFT of this dataset is

$$F ( μ , v ) = \frac{1}{MN} {\sum }_{x = 0}^{M - 1} {\sum }_{y = 0}^{N - 1} f ( x , y ) exp [ - 2 j π ( \frac{μ x}{M} + \frac{vy}{N} ) ] .$$

The variables μ and ν represent the spatial frequencies for the x and y coordinates, respectively.

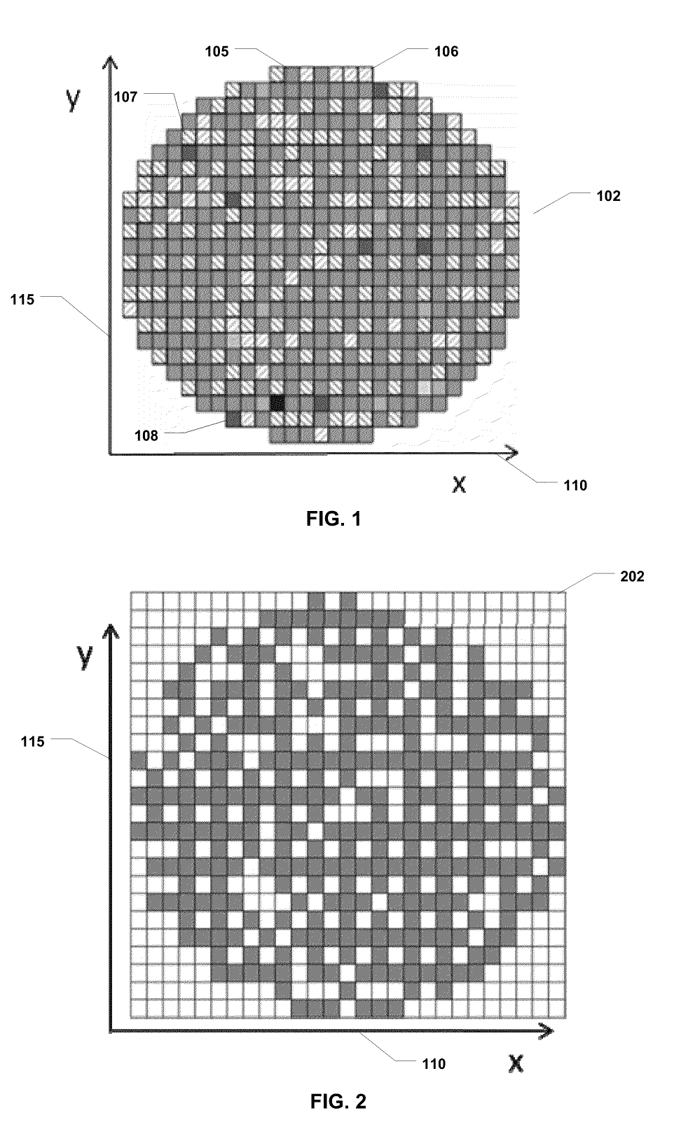

Frequency transforms, such as the DFT, can be efficiently applied to binary data. Accordingly, prior to transforming test data to the frequency domain, the test data is converted to binary information. This can be better understood with reference to FIG. 2, which illustrates a data set 202 based on the wafer 102. In the illustrated example of FIG. 2, each integrated circuit of the wafer 102 has been assigned a value of 1, as indicated by a blank or white box, or zero, as indicated by a shaded box. In particular, the integrated circuits having cross-hatch shading (and assigned to the associated bin) in FIG. 1 have been assigned a value of zero, while the integrated circuits having gray or darker shading (and assigned to one of the corresponding bins) have been assigned a value of one. In an embodiment, the values are assigned based on whether the bin of an integrated circuit indicates that the integrated circuit is a failed integrated circuit. Thus, in the illustrated embodiment of FIG. 1, the integrated circuits having a value of one have been tested to be failed integrated circuits, while integrated circuits having a value of zero are not failed integrated circuits.

In addition, some frequency transforms operate more efficiently, or produce results more readily subject to interpretation, if they are applied to a rectangular set of data. Accordingly, in the illustrated embodiment of FIG. 2, additional data points have been added to the data set 202 to form a rectangle. Further, each of the additional data points has been assigned a value of one. In other embodiments, each of the data points can be assigned a value of zero. In still another embodiment, each of the data points can be assigned a value randomly, or according to a predetermined pattern.

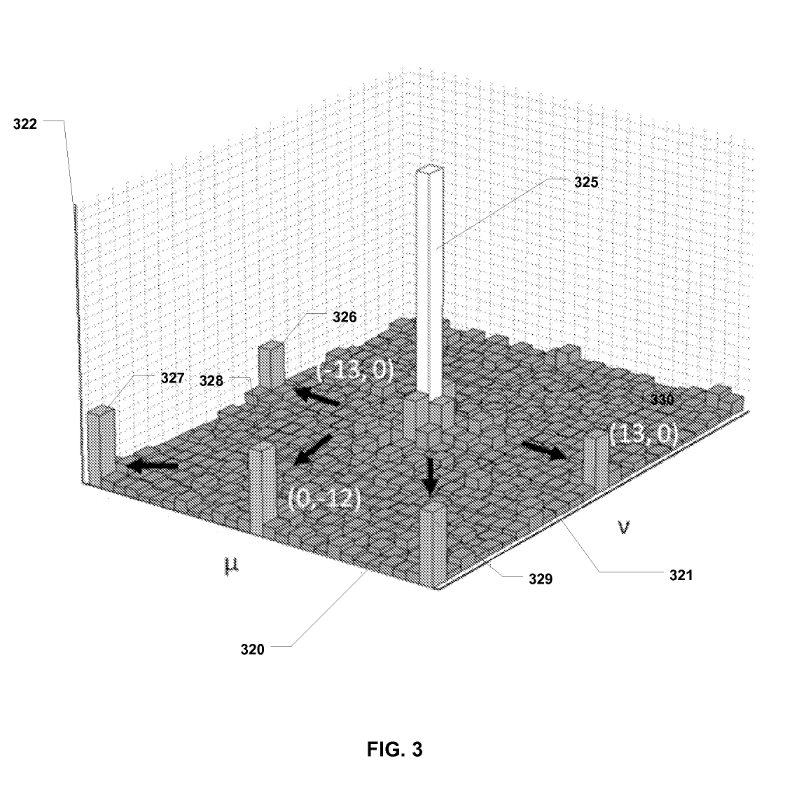

A frequency transform can be applied to the data set 202 to determine periodic features of the data. For example, the two dimensional DFT set forth above can be applied to the data, where f(x,y) is the value 1 or zero of each data point in the set, x is the x-coordinate of the corresponding data point, and y is the y-coordinate of the corresponding data point. The resulting frequency spectrum is illustrated at FIG. 3.

In the illustrated example of FIG. 3, axis 320 indicates the spatial frequency for the x-coordinate, axis 321 indicates the spatial frequency for the y-coordinate, and the axis 322 indicates the magnitude at the associated spatial frequency. The bar 325 component at μ=0 and ν=0 corresponds to the average failure rate on the wafer 102, including the extra data points that were added to create a rectangular grid for the data set 202. The relative heights of the bars 326-330 indicate a specific periodic failure pattern on the wafer 102. For example, there is a relatively strong signal at μ=0 and ν=−12, as indicated by bar 328. Since there are 24 y-values or rows in the data set, this component indicates that the failing integrated circuits have a spatial frequency of 12 cycles per 24 die along the y-axis of the wafer, or a failure average every two die along the y-axis. Similarly, since the wafer is 26 die wide, the frequency components at μ=−13 and ν=0 indicated by bar 330 corresponds to a failure signature that repeats 13 times in 26 die. The frequency components at the corner of the grid are associated with the repeating failure pattern along the diagonal.

In an embodiment, additional data can be added to the dataset to be transformed, and higher-dimensional transforms applied, to identify periodic errors across multiple wafers. For example, a different wafer number can be assigned to each wafer in a wafer set (referred to as a lot), and the wafer number used as a third dimension for a three-dimensional frequency transform, such as a three-dimensional DFT. In another embodiment, each lot of a set of lots is assigned a different number, and the lot number used as a fourth dimension for a four-dimensional frequency transform, such as four-dimensional DFT. This allows for identification of periodic errors across multiple wafers, and multiple wafer lots.

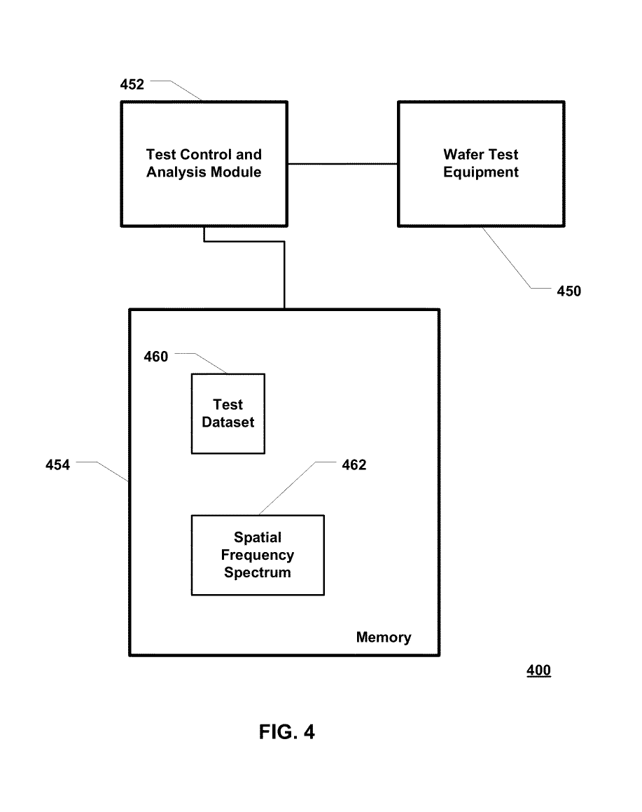

FIG. 4 illustrates a wafer testing system 400 in accordance with one embodiment of the present disclosure. The wafer testing system 400 includes wafer test equipment 450, test control and analysis module 452, and memory 454. The wafer test equipment 450 includes test probes, measuring equipment, equipment to set or adjust environmental conditions, and the like, sufficient to apply test stimuli to the integrated circuits of one or more wafers, and to read data indicative of each integrated circuits behavior in response to the test stimuli. Such data is referred to as the test dataset.

The test control and analysis module 452 is a set of one or more computer devices configured to determine a test configuration provided by a user, to configure the wafer test equipment 450 to set test conditions indicated by the test configuration, to control the test stimuli applied by the wafer test equipment as indicated by the test configuration, and to receive the resulting test dataset. In addition, the test control and analysis module 452 can analyze the resulting test dataset by sorting the test integrated circuits into bins, converting the bin information to binary test information, and applying a frequency transform to the binary test information to determine a spatial frequency spectrum based on the test dataset. The test control and analysis module 452 can also analyze the spatial frequency spectrum to detect spatial error patterns indicated by the test data set, and provide a report to the user based on the analysis.

The memory 454 is a computer readable medium such as a hard disk drive, solid state disk, random access memory, and the like, or any combination thereof that can store data. The memory 454 is employed by the test control and analysis module 452 to temporarily or permanently store data in the course of operations. In the illustrated example of FIG. 4, the memory 454 stores the test dataset 460 and a spatial frequency spectrum 462.

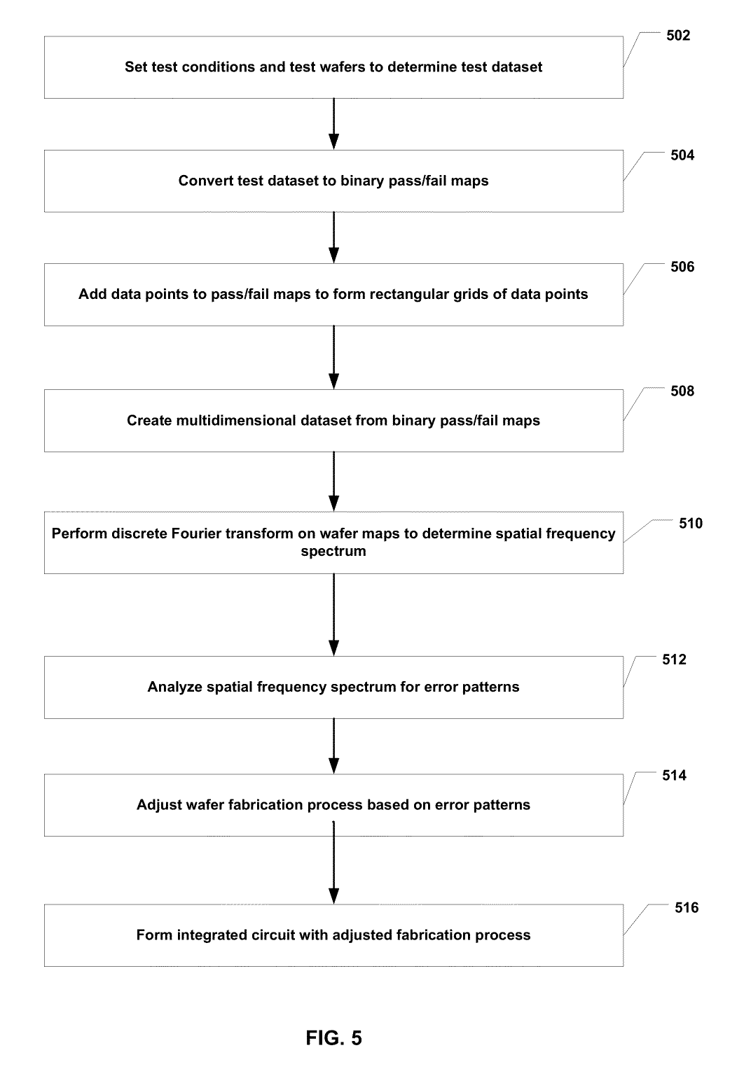

The operation of the wafer test system 400 can be better understood with reference to FIG. 5, which illustrates a flowchart of a method of testing integrated circuit wafers in accordance with one embodiment of the present disclosure. At block 502, the test control and analysis module 452 configures the test equipment 450 to set test conditions as indicated by configuration information provided by the user. In addition, once the test conditions are set, the test control and analysis module 452 controls the test equipment to apply stimuli (as indicated by the test configuration provided by the user) to the wafers under test. The wafer test equipment 450 measures the behavior of each integrated circuit under test in response to the stimuli, and provides data based on the measurements to the test control and analysis module 452, which stores the data as test dataset 460. In an embodiment, the test dataset 460 is wafer map data such as illustrated at FIG. 1.

At block 504, the test control and analysis module 452 converts the test dataset 460 to one or more binary pass/fail maps, such as illustrated at FIG. 2. In an embodiment, each wafer under test is associated with its own binary pass/fail map. Further, each integrated circuit in each wafer is assigned a binary value of one or zero based on whether the test dataset indicates that the integrated circuit complies with a specification. At block 506, additional data points are added to each binary pass/fail map so that each map forms a rectangular grid. In an embodiment, all the added data points are assigned a common binary value.

At block 508, the test control and analysis module 452 creates a multidimensional dataset based on the rectangular binary pass/fail maps. The multidimensional dataset includes a set of points, with each point in the set associated with a different integrated circuit of the wafers under test. In particular, each point of each binary pass/fail map is assigned coordinate values, indicating the position of the corresponding integrated circuit in the set of wafers under test, and a magnitude value corresponding to the binary value assigned to the integrated circuit. For example, in one embodiment each point includes an x-coordinate value (indicating the associated integrated circuit's position along the x-axis), a y-coordinate value (indicating the associated integrated circuit's position along the y-axis), and a magnitude value. In another embodiment, each point includes a wafer number (with each wafer number associated with a different one of the wafers under test), an x-coordinate value, a y-coordinate value, and a magnitude value. In still another embodiment each point includes a lot number, a wafer number (with each wafer number associated with a different one of the wafers in the lot), an x-coordinate value, a y-coordinate value, and a magnitude value.

At block 510 the test control and analysis module 452 performs a discrete Fourier transform on the multidimensional dataset. The DFT is an N-dimensional DFT, where N is an integer corresponding to the number of coordinate values associated with each point in the multidimensional dataset. Thus, the DFT can be a 2-dimensional DFT (for datasets having only x and y coordinate values), a 3-dimensional DFT (for datasets having, for example, wafer numbers and x and y coordinate values), a 4-dimensional DFT (for datasets having, for example, lot numbers, wafer numbers and x and y coordinate values), or can be a higher dimensional DFT. The test control and analysis module 452 stores the resulting spatial frequency spectrum at the memory 454 as spatial frequency spectrum 462.

At block 512 the spatial frequency spectrum 464 is analyzed to detect spatial error patterns, such as periodic error patterns, in the test dataset 460. In an embodiment, the test control and analysis module 452 can perform this analysis automatically, by comparing the magnitude of each frequency component indicated by the spatial frequency spectrum 464 to a threshold, and determining that an error exists if the magnitude exceeds the threshold. The threshold can be a fixed threshold, a threshold that depends on the magnitude of the frequency components surrounding the frequency component of interest, and the like.

At block 514 the wafer fabrication process used to form the wafers under test is adjusted based on any error patterns detected by analyzing the spatial frequency spectrum 464. In an embodiment, the test control and analysis module 452 can automatically adjust the fabrication process by changing the fabrication process conditions, adjusting equipment parameters, removing equipment from the process, and the like. At block 516, integrated circuits are formed using the adjusted fabrication process.

Referring again to FIG. 4, in an embodiment the test control and analysis module is a computer device having one or more processors that can be manipulated by instructions stored at the computer readable medium of memory 454. The instructions can manipulate the processor to perform one or more of the methods described herein, individually or in combination.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A computer-implemented method, comprising:
applying a frequency transform to integrated circuit wafer test data to determine an error pattern associated with an integrated circuit wafer.

2. The method of claim 1, wherein the frequency transform comprises a Fourier transform.

3. The method of claim 1, wherein the frequency transform comprises a multidimensional transform.

4. The method of claim 3, wherein the multidimensional transform includes at least three dimensions.

5. The method of claim 4, wherein at least one dimension of the multidimensional transform is indicative of a wafer lot number.

6. The method of claim 3, wherein the multidimensional transform includes at least four dimensions.

7. The method of claim 1, further comprising:
determining the error pattern by comparing a frequency component indicated by the frequency transform to a defined threshold value.

8. The method of claim 1, further comprising:
determining the error pattern by comparing a first frequency component indicated by the frequency transform to a second frequency component indicated by the frequency transform.

9. The method of claim 1, further comprising:
determining the error pattern by comparing a frequency component indicated by the frequency transform to an average of a plurality of frequency components indicated by the frequency transform.

10. The method of claim 1, further comprising:
modifying a wafer fabrication process based on the error pattern to determine a modified wafer fabrication process; and
producing an integrated circuit using the modified wafer fabrication process.

11. A computer-implemented method, comprising:
receiving wafer sort data associated with an integrated circuit wafer;
transforming the wafer sort data according to a frequency transform to determine a spatial frequency spectrum for the integrated circuit wafer; and
determining an error pattern for the first integrated circuit wafer based on the spatial frequency spectrum.

12. The method of claim 11, wherein the wafer sort data comprises data assigning each integrated circuit of a wafer to one of three or more bins, and wherein transforming the wafer sort data comprises:
converting the wafer sort data to pass-fail data by assigning each integrated circuit of a wafer to either of two categories, the categories indicating whether an integrated circuit has passed or failed a designated test; and
transforming the pass-fail data according to the frequency transform.

13. The method of claim 12, wherein transforming the wafer sort data further comprises adding a set of data points to the pass-fail data such that the pass-fail data is associated with a rectangular grid of data points.

14. A computer readable medium storing instructions to manipulate a processor, the instructions comprising instructions to apply a frequency transform to integrated circuit wafer test data to determine an error pattern associated with an integrated circuit wafer.

15. The computer readable medium of claim 14, wherein the frequency transform comprises a Fourier transform.

16. The computer readable medium of claim 14, wherein the frequency transform comprises a multidimensional transform.

17. The computer readable medium of claim 16, wherein the multidimensional transform includes at least three dimensions.

18. The computer readable medium of claim 17, wherein at least one dimension of the multidimensional transform is indicative of a wafer lot number.

19. The computer readable medium of claim 16, wherein the multidimensional transform includes at least four dimensions.

20. The computer readable medium of claim 14, wherein the instructions comprise instructions to determine the error pattern by comparing a frequency component indicated by the frequency transform to a defined threshold value.
